(19) United States
(12) Patent Application Publication
(10) Pub. No.: US 2022/0155122 A1
(43) Pub. Date: May 19, 2022

(54) AIR FLOW RATE MEASUREMENT DEVICE

(71) Applicant: DENSO CORPORATION, Kariya-city (JP)

(72) Inventors: Takashi OOGA, Kariya-city (JP); Yasushi GOKA, Kariya-city (JP)

(21) Appl. No.: 17/666,059

(22) Filed: Feb. 7, 2022

Related U.S. Application Data
(63) Continuation of application No. PCT/JP2020/033286, filed on Sep. 2, 2020.

(30) Foreign Application Priority Data
Sep. 4, 2019 (JP) 2019-161243

(51) Int. Cl. G01F 1/69; G01F 15/14

(52) U.S. Cl. CPC G01F 1/69; G01F 15/14

(57) ABSTRACT

An air flow rate measurement device includes a housing, a flow rate sensing device and a physical quantity sensing device. The flow rate sensing device is located in a flow rate measurement passage of the housing and outputs a signal which corresponds to a flow rate of air flowing in the flow rate measurement passage. The physical quantity sensing device is located in a physical quantity measurement main passage of the housing that is communicated with a physical quantity measurement main passage inlet and a physical quantity measurement main passage outlet of the housing. The physical quantity sensing device outputs a signal which corresponds to a physical quantity of the air flowing in the physical quantity measurement main passage. The housing has the physical quantity measurement main passage outlet as one of a plurality of physical quantity measurement main passage outlets.

### CROSS REFERENCE TO RELATED APPLICATIONS

This application is a continuation application of International Patent Application No. PCT/JP2020/033286 filed on Sep. 2, 2020, which designated the U.S. and claims the benefit of priority from Japanese Patent Application No. 2019-161243 filed on Sep. 4, 2019. The entire disclosures of all of the above applications are incorporated herein by reference.

### TECHNICAL FIELD

The present disclosure relates to an air flow rate measurement device.

### BACKGROUND

Previously, there has been proposed a thermal flow meter that measures a flow rate of air flowing in a flow rate measurement passage which communicates between a flow rate measurement passage inlet formed at one end surface of a housing and a flow rate measurement passage outlet formed at the other end surface of the housing.

### SUMMARY

This section provides a general summary of the disclosure, and is not a comprehensive disclosure of its full scope or all of its features.

According to the present disclosure, there is provided an air flow rate measurement device that includes a housing, a flow rate sensing device and a physical quantity sensing device. The flow rate sensing device is located in a flow rate measurement passage of the housing and is configured to output a signal which corresponds to a flow rate of air flowing in the flow rate measurement passage. The physical quantity sensing device is located in a physical quantity measurement main passage of the housing that is communicated with a physical quantity measurement main passage inlet and a physical quantity measurement main passage outlet of the housing. The physical quantity sensing device is configured to output a signal which corresponds to a physical quantity of the air flowing in the physical quantity measurement main passage. The housing has the physical quantity measurement main passage outlet as one of a plurality of physical quantity measurement main passage outlets formed at a primary lateral surface of the housing.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram of an engine system, in which an air flow rate measurement device of respective embodiments is used.

FIG. 2 is a front view of the air flow rate measurement device of a first embodiment.

FIG. 3 is a side view of the air flow rate measurement device.

FIG. 4 is another side view of the air flow rate measurement device.

FIG. 5 is a cross-sectional view taken along line V-V in FIG. 2.

FIG. 6 is an enlarged cross-sectional view taken along line VI-VI in FIG. 2.

FIG. 7 is an enlarged view of an area VII in FIG. 3.

FIG. 8 is an enlarged view of an area VIII in FIG. 4.

FIG. 9 is a front view of an air flow rate measurement device of a second embodiment.

FIG. 10 is a side view of the air flow rate measurement device.

FIG. 11 is another side view of the air flow rate measurement device.

FIG. 12 is a front view of an air flow rate measurement device of a third embodiment.

FIG. 13 is an enlarged view of an area XIII in FIG. 12.

FIG. 14 is a cross-sectional view of an air flow rate measurement device of a fourth embodiment.

FIG. 15 is an enlarged cross-sectional view taken along line XV-XV in FIG. 14.

FIG. 16 is a side view of the air flow rate measurement device.

FIG. 17 is an enlarged view of an area XVII in FIG. 16.

FIG. 18 is a side view of the air flow rate measurement device.

FIG. 19 is an enlarged view of an area XIX in FIG. 18.

### DETAILED DESCRIPTION

Previously, there has been proposed a thermal flow meter that measures a flow rate of air flowing in a flow rate measurement passage which communicates between a flow rate measurement passage inlet formed at one end surface of a housing and a flow rate measurement passage outlet formed at the other end surface of the housing.

In the thermal flow meter, in order to measure the temperature of the air besides the flow rate of the air, another inlet is formed at the one end surface of the housing at a location which is different from a location of the flow rate measurement passage inlet. Furthermore, another outlet is formed at a lateral surface of the housing which is connected to the one end surface and the other end surface of the housing. Also, a temperature sensing device, which senses the temperature of the air flowing from the other inlet toward the other outlet, is located at the inside of the housing. This temperature sensing device is cooled by the air flowing from the other inlet toward the other outlet, so that the influences of the heat conduction and the heat transfer of the housing are alleviated.

According to the study by the inventors of the present application, in this structure, the flow rate of the air, which flows from the other inlet toward the other outlet, may be increased by increasing a passage cross-sectional area of the other outlet such that the cooling of the temperature sensing device is facilitated by the air flowing from the other inlet toward the other outlet. However, in the case where the passage cross-sectional area of the other outlet is increased, a size of a contact area between an inner periphery of the other outlet of the housing and the air flowing from the other inlet toward the other outlet is increased. Therefore, the air, which flows from the other inlet toward the other outlet, is likely to be disturbed when the air is discharged from the other outlet. Thus, the air, which flows from the other inlet toward the other outlet, is likely to generate a relatively large vortex when the air is discharged from the other outlet. When this relatively large vortex flows toward the flow rate measurement passage outlet, the pressure of the flow rate measurement passage outlet is likely to be changed. This change in the pressure will cause a change in the flow of the air in the flow rate measurement passage, so that measurement accuracy of the flow rate of the air in the flow rate measurement passage is likely to be deteriorated.

According to one aspect of the present disclosure, there is provided an air flow rate measurement device including:
a housing that has:
   a base surface;
   a back surface that is opposed to the base surface;
   a primary lateral surface that is connected to one end part of the base surface and one end part of the back surface;
   a secondary lateral surface that is connected to another end part of the base surface, which is opposite to the primary lateral surface, and another end part of the back surface, which is opposite to the primary lateral surface;
   a flow rate measurement passage inlet that is formed at the base surface;
   a flow rate measurement passage outlet that is formed at the back surface;
   a flow rate measurement passage that is communicated with the flow rate measurement passage inlet and the flow rate measurement passage outlet;
   a physical quantity measurement main passage inlet that is formed at the base surface;
   a physical quantity measurement main passage outlet that is formed at the primary lateral surface; and
   a physical quantity measurement main passage that is communicated with the physical quantity measurement main passage inlet and the physical quantity measurement main passage outlet;
a flow rate sensing device that is located in the flow rate measurement passage and is configured to output a signal which corresponds to a flow rate of air flowing in the flow rate measurement passage; and
a physical quantity sensing device that is located in the physical quantity measurement main passage and is configured to output a signal which corresponds to a physical quantity of the air flowing in the physical quantity measurement main passage, wherein:
the housing has the physical quantity measurement main passage outlet as one of a plurality of physical quantity measurement main passage outlets formed at the primary lateral surface.

With the above-described structure, the measurement accuracy of the flow rate of the air can be increased.

Hereinafter, embodiments of the present disclosure will be described with reference to the drawings. In each of the following embodiments, the same or equivalent portions will be indicated by the same reference signs, and redundant description thereof will be omitted for the sake of simplicity.

### First Embodiment

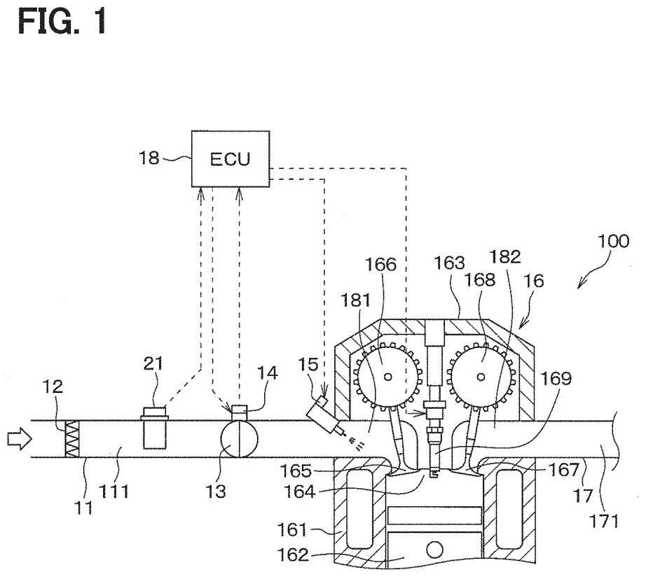

An air flow rate measurement device 21 is used, for example, in an air intake system of an engine system 100 installed to a vehicle. First of all, this engine system 100 will be described. Specifically, as shown in FIG. 1, the engine system 100 includes an air intake pipe 11, an air cleaner 12, an air flow rate measurement device 21, a throttle valve 13, a throttle sensor 14, injectors 15, an engine 16, an exhaust pipe 17 and an electronic control device 18. In this description, intake air refers to air that is drawn into the engine 16. Furthermore, exhaust gas refers to gas that is discharged from the engine 16.

The air intake pipe 11 is shaped into a cylindrical tubular form and has an air intake passage 111. The air intake passage 111 is configured to conduct the air to be drawn into the engine 16.

The air cleaner 12 is installed in the air intake pipe 11 at an upstream side section of the air intake passage 111, which is located on an upstream side in a flow direction of the air flowing in the air intake passage 111. Furthermore, the air cleaner 12 is configured to remove foreign objects, such as dust, contained in the air flowing in the air intake passage 111.

The air flow rate measurement device 21 is located on a downstream side of the air cleaner 12 in the flow direction of the air flowing in the air intake passage 111. The air flow rate measurement device 21 is configured to measure the flow rate of the air, which flows in the air intake passage 111, at a location between the air cleaner 12 and the throttle valve 13. In this embodiment, the air flow rate measurement device 21 is also configured to measure a physical quantity of the air that flows in the air intake passage 111. Details of the air flow rate measurement device 21 will be described later. In this embodiment, the physical quantity of the air, which flows in the air intake passage 111, is a physical quantity that is different from the flow rate of the air, which flows in the air intake passage 111, and this physical quantity is, for example, the temperature, the relative humidity or the pressure of the air as discussed later in detail.

The throttle valve 13 is located on a downstream side of the air flow rate measurement device 21 in the flow direction of the air flowing in the air intake passage 111. Furthermore, the throttle valve 13 is shaped into a circular disk form and is rotated by an electric motor (not shown). The throttle valve 13 is configured to adjust a size of a passage cross-sectional area of the air intake passage 111 and thereby adjust the flow rate of the air to be drawn into the engine 16 through rotation of the throttle valve 13.

The throttle sensor 14 is configured to output a measurement signal, which corresponds to an opening degree of the throttle valve 13, to the electronic control device 18.

The injector 15 is configured to inject the fuel into a combustion chamber 164 of the engine 16 based on a signal outputted from the electronic control device 18 described later.

The engine 16 is an internal combustion engine where a mixture gas, which is a mixture of the air flowing from the air intake passage 111 through the throttle valve 13 and the fuel injected from the injector 15, is combusted in the combustion chamber 164. An explosive force, which is generated by this combustion, causes a piston 162 of the engine 16 to reciprocate in a cylinder 161. Specifically, the engine 16 includes cylinders 161, pistons 162, a cylinder head 163, combustion chambers 164, intake valves 165, an intake valve drive device 166, exhaust valves 167, an exhaust valve drive device 168 and spark plugs 169.

The cylinder 161 is shaped in a tubular form and receives the piston 162. The piston 162 is configured to reciprocate in the cylinder 161 in an axial direction of the cylinder 161. The cylinder head 163 is installed at upper portions of the cylinders 161. Furthermore, the cylinder head 163 is connected to the air intake pipe 11 and the exhaust pipe 17 and has a first cylinder passage 181 and a second cylinder passage 182. The first cylinder passage 181 is communicated with the air intake passage 111. The second cylinder passage 182 is communicated with an exhaust passage 171 of the exhaust pipe 17 described later. The combustion chamber 164 is defined by the cylinder 161, a top surface of the piston 162 and a lower surface of the cylinder head 163. The intake valve 165 is placed in the first cylinder passage 181 and is configured to be driven by the intake valve drive device 166 to open and close the combustion chamber 164 at the first cylinder passage 181 side. The exhaust valve 167 is placed in the second cylinder passage 182 and is configured to be driven by the exhaust valve drive device 168 to open and close the combustion chamber 164 at the second cylinder passage 182 side.

The spark plug 169 is configured to ignite the mixture gas of the combustion chamber 164, which is the mixture of the air flowing from the air intake passage 111 through the throttle valve 13 and the fuel injected from the injector 15, based on the signal outputted from the electronic control device 18.

The exhaust pipe 17 is shaped in a cylindrical tubular form and has the exhaust passage 171. The exhaust passage 171 conducts the gas which is combusted in the combustion chambers 164. The gas, which flows in the exhaust passage 171, is purified by an exhaust gas purification device (not shown).

The electronic control device 18 includes a microcomputer as its main component and thereby has a CPU, a ROM, a RAM, an I/O device and a bus line for connecting these devices. Here, for example, the electronic control device 18 controls the opening degree of the throttle valve 13 based on, for example, the flow rate of the air and the physical quantity of the air measured with the air flow rate measurement device 21 and the current opening degree of the throttle valve 13. Furthermore, the electronic control device 18 controls a fuel injection amount of the respective injectors 15 and ignition timing of the respective spark plugs 169 based on, for example, the flow rate of the air and the physical quantity of the air measured with the air flow rate measurement device 21 and the current opening degree of the throttle valve 13. In FIG. 1, the electronic control device 18 is indicated as an ECU.

The engine system 100 has the above-described structure. Next, the air flow rate measurement device 21 will be described in detail.

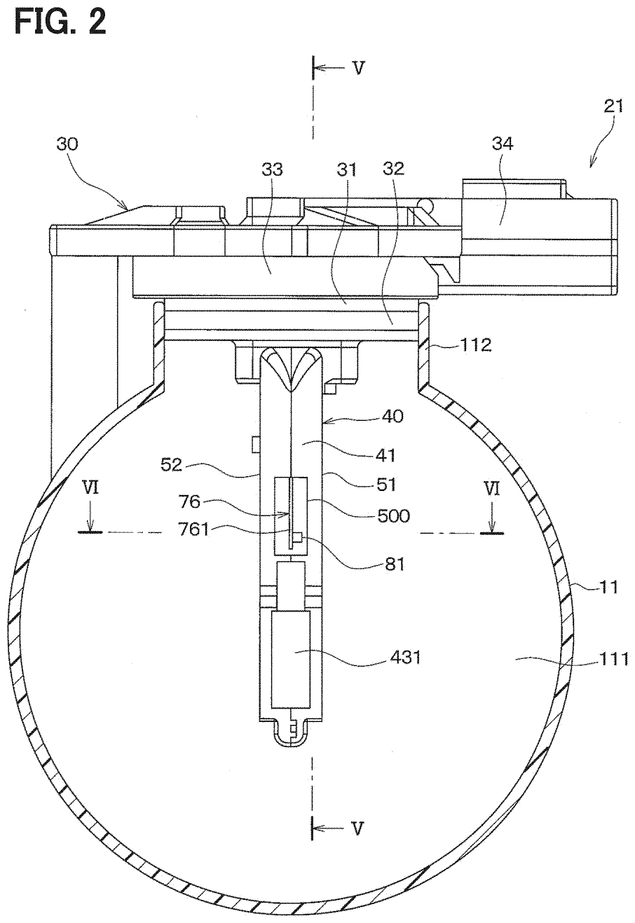

As shown in FIGS. 2 to 8, the air flow rate measurement device 21 includes a housing 30, a flow rate sensing device 75, a circuit board 76 and a primary physical quantity sensing device 81.

As shown in FIG. 2, the housing 30 is installed to a pipe extension 112 that is connected to a peripheral wall of the air intake pipe 11. The pipe extension 112 is shaped in a cylindrical tubular form and extends from the peripheral wall of the air intake pipe 11 in a radial direction of the air intake pipe 11 from a radially inner side toward a radially outer side. Furthermore, the housing 30 includes a holding portion 31, a seal member 32, a lid 33, a connector cover 34, terminals 35 and a bypass portion 40.

The holding portion 31 is shaped in a cylindrical tubular form and is fixed to the pipe extension 112 when an outer surface of the holding portion 31 is fitted to an inner surface of the pipe extension 112. Furthermore, a groove, into which the seal member 32 is fitted, is formed at an outer peripheral surface of the holding portion 31.

The seal member 32 is for example, an O-ring and is installed in the groove of the holding portion 31. The seal member 32 closes a passage in the pipe extension 112 when the seal member 32 contacts the pipe extension 112. Thereby, leakage of the air, which flows in the air intake passage 111, to the outside through the pipe extension 112 is limited.

The lid 33 is shaped in a bottomed tubular form and is connected to the holding portion 31 in an axial direction of the holding portion 31. Furthermore, a length of the lid 33, which is measured in a radial direction of the holding portion 31, is larger than a diameter of the pipe extension 112, and the lid 33 closes a hole of the pipe extension 112.

The connector cover 34 is connected to the lid 33 and extends from a radially inner side toward a radially outer side in the radial direction of the holding portion 31. Furthermore, the connector cover 34 is shaped in a tubular form and receives one end parts of the terminals 35.

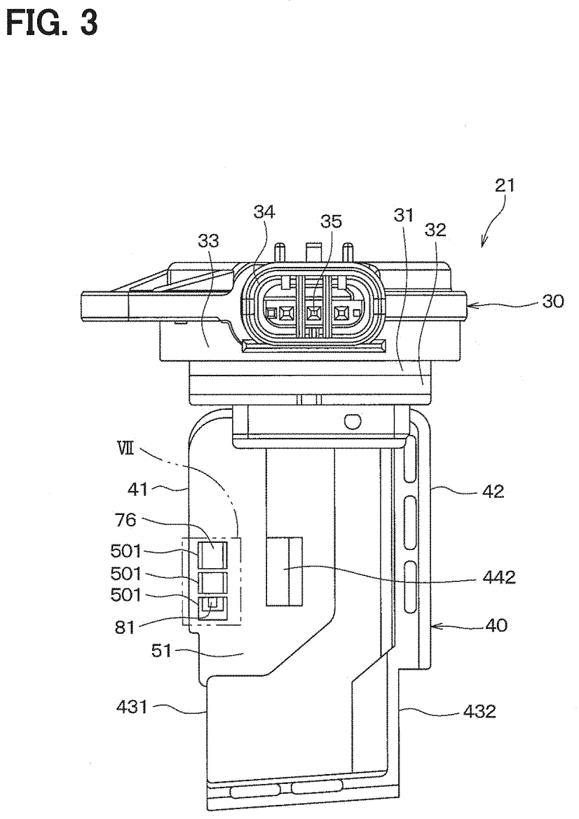

As shown in FIG. 3, the one end parts of the terminals 35 are received in the connector cover 34. Furthermore, although not depicted in the drawing, the one end parts of the terminals 35 are connected to the electronic control device 18. Also, center parts of the terminals 35 are received in the lid 33 and the holding portion 31. The other end parts of corresponding ones of the terminals 35 are connected to the circuit board 76 described later.

The bypass portion 40 includes a plurality of passages and is shaped in a planar form. Specifically, as shown in FIGS. 2 to 8, the bypass portion 40 includes a housing base surface 41, a housing back surface 42, a primary housing lateral surface 51 and a secondary housing lateral surface 52. Furthermore, the bypass portion 40 includes a flow rate measurement main passage inlet (flow rate measurement passage inlet) 431, a flow rate measurement main passage outlet (flow rate measurement passage outlet) 432, a flow rate measurement main passage (flow rate measurement passage) 43, a flow rate measurement sub-passage inlet 441, a flow rate measurement sub-passage (flow rate measurement passage) 44 and a plurality of flow rate measurement sub-passage outlets 442. Also, the bypass portion 40 includes a physical quantity measurement main passage inlet 500, a physical quantity measurement main passage 50, a plurality of primary physical quantity measurement main passage outlets (a plurality of physical quantity measurement main passage outlets) 501, a plurality of primary main passage outlet partitions 61, a plurality of secondary physical quantity measurement main passage outlets (a plurality of physical quantity measurement main passage outlets) 502 and a plurality of secondary main passage outlet partitions 62. In the following description, a side of the bypass portion 40, at which the holding portion 31 of the housing 30 is placed, will be referred to as an upper side. Furthermore, another side of the bypass portion 40, which is opposite to the holding portion 31, will be referred to as a lower side.

The housing base surface 41 is located on an upstream side in the flow direction of the air flowing in the air intake passage 111. The housing back surface 42 is located on a side that is opposite to the housing base surface 41. The primary housing lateral surface 51 serves as a primary lateral surface and is connected to one end part of the housing base surface 41 and one end part of the housing back surface 42. The secondary housing lateral surface 52 serves as a secondary lateral surface and is connected to another end part of the housing base surface 41 and another end part of the housing back surface 42, which are opposite to the primary housing lateral surface 51. Furthermore, the housing base surface 41, the housing back surface 42, the primary housing lateral surface 51 and the secondary housing lateral surface 52 are respectively shaped in a stepped form.

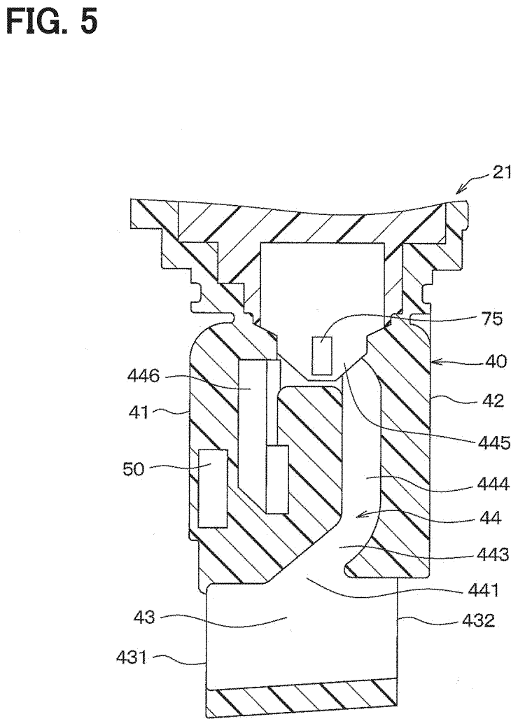

As shown in FIGS. 2 to 5, the flow rate measurement main passage inlet 431 is formed at the housing base surface 41 and introduces a portion of the air, which flows in the air intake passage 111, into the flow rate measurement main passage 43. As shown in FIG. 5, the flow rate measurement main passage 43 is communicated with the flow rate measurement main passage inlet 431 and the flow rate measurement main passage outlet 432. As shown in FIGS. 3 to 5, the flow rate measurement main passage outlet 432 is formed at the housing back surface 42.

As shown in FIG. 5, the flow rate measurement sub-passage inlet 441 is formed at the upper side of the flow rate measurement main passage 43 and introduces a portion of the air, which flows in the flow rate measurement main passage 43, into the flow rate measurement sub-passage 44. The flow rate measurement sub-passage 44 is a passage that is branched from the middle of the flow rate measurement main passage 43. The flow rate measurement sub-passage 44 includes an introducing portion 443, a rear vertical portion 444, a return portion 445 and a front vertical portion 446. The introducing portion 443 is connected to the flow rate measurement sub-passage inlet 441 and extends from the flow rate measurement sub-passage inlet 441 in an upward direction and also in a direction that is directed from the flow rate measurement sub-passage inlet 441 toward the housing back surface 42. Thereby, a portion of the air, which flows in the flow rate measurement main passage 43, can be easily introduced into the flow rate measurement sub-passage 44. The rear vertical portion 444 is connected to an end part of the introducing portion 443, which is opposite to the flow rate measurement sub-passage inlet 441, and the rear vertical portion 444 extends from this end part of the introducing portion 443 in the upward direction. The return portion 445 is connected to an end part of the rear vertical portion 444, which is opposite to the introducing portion 443, and the return portion 445 extends from this end part of the rear vertical portion 444 toward the housing base surface 41. The front vertical portion 446 is connected to an end part of the return portion 445, which is opposite to the rear vertical portion 444, and the front vertical portion 446 extends from this end part of the return portion 445 in the downward direction. In a cross-sectional view shown in FIG. 5, in order to dearly indicate the respective passages, an outline of the flow rate measurement sub-passage inlet 441, an outline of the respective secondary physical quantity measurement main passage outlets 502 described later, and an outline of the circuit board 76 are omitted.

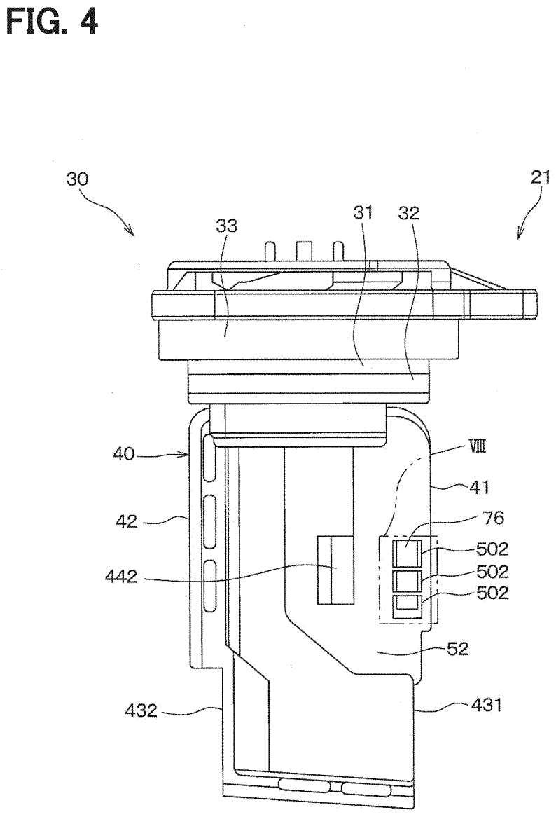

As shown in FIGS. 3 and 4, the flow rate measurement sub-passage outlets 442 are respectively formed at the primary housing lateral surface 51 and the secondary housing lateral surface 52 and are communicated with the front vertical portion 446 and the outside of the housing 30.

As shown in FIG. 2, the physical quantity measurement main passage inlet 500 is formed at the housing base surface 41 at a location, which is on the upper side of the flow rate measurement main passage inlet 431. The physical quantity measurement main passage inlet 500 introduces a portion of the air, which flows in the air intake passage 111, into the physical quantity measurement main passage 50.

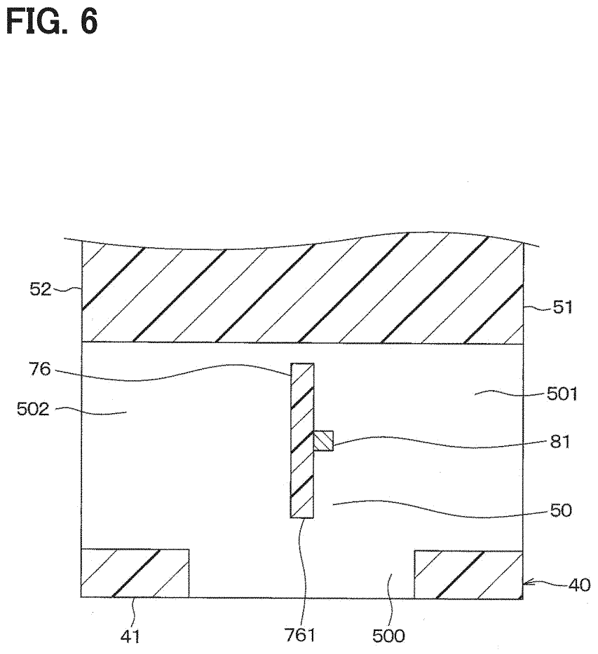

As shown in FIGS. 5 and 6, the physical quantity measurement main passage 50 communicates the physical quantity measurement main passage inlet 500 to the primary physical quantity measurement main passage outlets 501 and the secondary physical quantity measurement main passage outlets 502.

As shown in FIGS. 3, 6 and 7, the primary physical quantity measurement main passage outlets 501 are formed at the primary housing lateral surface 51.

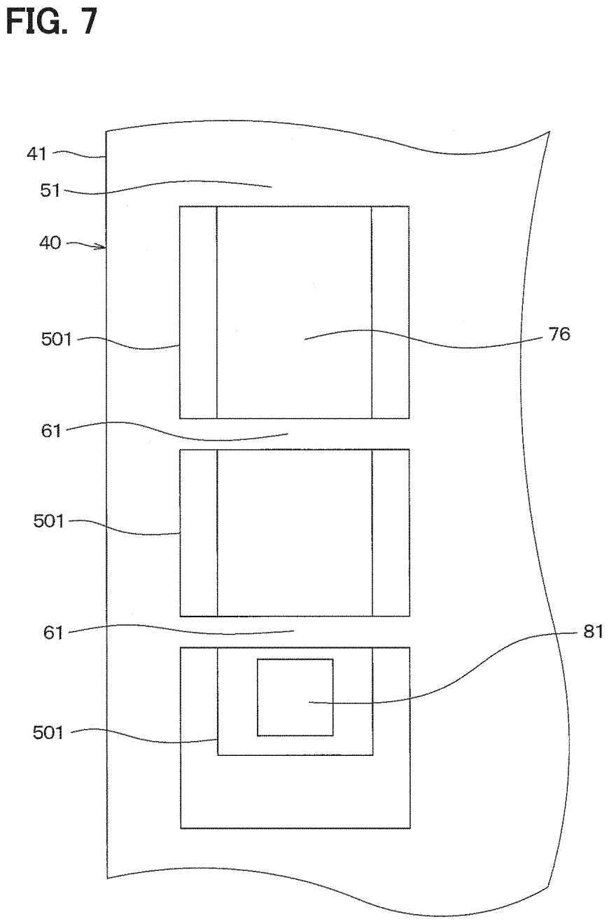

As shown in FIG. 7, each of the primary main passage outlet partitions 61 is formed between corresponding adjacent two of the primary physical quantity measurement main passage outlets 501. For example, the primary main passage outlet partition 61 extends in a direction that is perpendicular to the top-to-bottom direction. Furthermore, each of the primary main passage outlet partitions 61 partitions between the corresponding adjacent two of the primary physical quantity measurement main passage outlets 501. In this instance, the number of the primary main passage outlet partitions 61 is two, and these two primary main passage outlet partitions 61 are arranged in parallel in the top-to-bottom direction. Furthermore, the number of the primary physical quantity measurement main passage outlets 501 is three, and these three primary physical quantity measurement main passage outlets 561 are arranged in parallel in the top-to-bottom direction.

As shown in FIGS. 4, 6 and 8, the secondary physical quantity measurement main passage outlets 502 are formed at the secondary housing lateral surface 52.

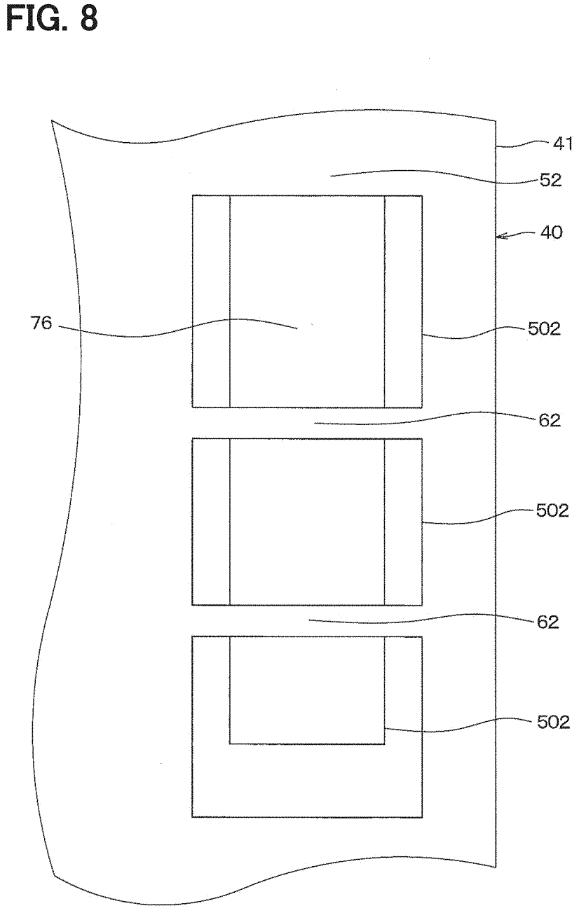

As shown in FIG. 8, each of the secondary main passage outlet partitions 62 is formed between corresponding adjacent two of the secondary physical quantity measurement main passage outlets 502. For example, the secondary main passage outlet partition 62 extends in the direction that is perpendicular to the top-to-bottom direction. Furthermore, each of the secondary main passage outlet partitions 62 partitions between the corresponding adjacent two of the secondary physical quantity measurement main passage outlets 502. In this instance, the number of the secondary main passage outlet partition 62 is two, and these two secondary main passage outlet partitions 62 are arranged in parallel in the top-to-bottom direction. Furthermore, the number of the secondary physical quantity measurement main passage outlets 502 is three, and these three secondary physical quantity measurement main passage outlets 502 are arranged in parallel in the top-to-bottom direction.

As shown in FIG. 5, the flow rate sensing device 75 is installed in the return portion 445 of the flow rate measurement sub-passage 44 and is configured to output a signal that corresponds to the flow rate of the air flowing in the flow rate measurement sub-passage 44. Specifically, the flow rate sensing device 75 includes a semiconductor that has a heating element and a thermosensitive element. This semiconductor contacts the air flowing in the flow rate measurement sub-passage 44, and thereby heat transfer occurs between the semiconductor and the air flowing in the flow rate measurement sub-passage 44. Due to this heat transfer, the temperature of the semiconductor changes. This temperature change correlates to the flow rate of the air flowing in the flow rate measurement sub-passage 44. Therefore, at the flow rate sensing device 75, a signal, which corresponds to this temperature change, is outputted, and thereby the flow rate sensing device 75 outputs a signal that corresponds to the flow rate of the air flowing in the flow rate measurement sub-passage 44. Furthermore, the flow rate sensing device 75 is electrically connected to the other end part of the corresponding terminal 35. In this way, the output signal of the flow rate sensing device 75 is transmitted to the electronic control device 18 through the terminal 35.

The circuit board 76 is, for example, a printed circuit board. Furthermore, as shown in FIGS. 2 and 6, the circuit board 76 is placed at the physical quantity measurement main passage 50. A circuit board's thicknesswise surface 761, which is a surface of the circuit board 76 that extends in a plate thickness direction of the circuit board 76, is opposed to the physical quantity measurement main passage inlet 500. Furthermore, as shown in FIGS. 3, 4 and 6 to 8, two opposed surfaces of the circuit board 76, each of which extends in a longitudinal direction and a width direction of the circuit board 76, are respectively opposed to the primary physical quantity measurement main passage outlets 501 and the secondary physical quantity measurement main passage outlets 502. Furthermore, the circuit board 76 is electrically connected to the other ends of the corresponding terminals 35.

As shown in FIG. 6, the primary physical quantity sensing device 81 is placed in the physical quantity measurement main passage 50 and is installed to the circuit board 76. Also, as shown in FIG. 2, the primary physical quantity sensing device 81 is opposed to the physical quantity measurement main passage inlet 500. Furthermore, as shown in FIG. 3, the primary physical quantity sensing device 81 is opposed to one of the primary physical quantity measurement main passage outlets 501.

The primary physical quantity sensing device 81 outputs a signal which corresponds to the physical quantity of the air that flows in the physical quantity measurement main passage 50. In this instance, the physical quantity of the air, which flows in the physical quantity measurement main passage 50, is the temperature of the air, which flows in the physical quantity measurement main passage 50. The primary physical quantity sensing device 81 includes, for example, a thermistor (not shown) and outputs a signal that corresponds to the temperature of the air which flows in the physical quantity measurement main passage 50. Furthermore, since the primary physical quantity sensing device 81 is installed to the circuit board 76, the output signal of the primary physical quantity sensing device 81 is transmitted to the electronic control device 18 through the circuit board 76 and the corresponding terminal 35.

The air flow rate measurement device 21 is constructed in the above-described manner. Next, the measurement of the flow rate and the temperature by the air flow rate measurement device 21 will be described.

A portion of the air, which flows in the air intake passage 111 flows into the flow rate measurement main passage inlet 431. The air, which flows from the flow rate measurement main passage inlet 431, flows in the flow rate measurement main passage 43 toward the flow rate measurement main passage outlet 432. A portion of the air, which flows in the flow rate measurement main passage 43, is discharged to the outside of the housing 30 through the flow rate measurement main passage outlet 432.

Furthermore, another portion of the air, which flows in the flow rate measurement main passage 43, flows into the flow rate measurement sub-passage inlet 441. The air, which flows from the flow rate measurement sub-passage inlet 441, flows in the return portion 445 after passing through the introducing portion 443 and the rear vertical portion 444 of the flow rate measurement sub-passage 44. A portion of the air, which flows in the return portion 445, contacts the flow rate sensing device 75. Due to the contact of the flow rate sensing device 75 with the air, the flow rate sensing device 75 outputs a signal that corresponds to the flow rate of the air, which flows in the flow rate measurement sub-passage 44. The output signal of the flow rate sensing device 75 is transmitted to the electronic control device 18 through the corresponding terminal 35. Furthermore, a portion of the air, which flows in the return portion 445, is discharged to the outside of the housing 30 through the front vertical portion 446 and the flow rate measurement sub-passage outlets 442 of the flow rate measurement sub-passage 44.

Furthermore, a portion of the air, which flows in the air intake passage 111, flows into the physical quantity measurement main passage inlet 500. The air, which flows from the physical quantity measurement main passage inlet 500, flows in the physical quantity measurement main passage 50. A portion of the air, which flows in the physical quantity measurement main passage 50, contacts the primary physical quantity sensing device 81. Due to the contact of the primary physical quantity sensing device 81 with the air, the primary physical quantity sensing device 81 outputs the signal that corresponds to the temperature of the air, which flows in the physical quantity measurement main passage 50. The output signal of the primary physical quantity sensing device 81 is transmitted to the electronic control device 18 through the circuit board 76 and the corresponding terminal 35. Furthermore, the air, which flows in the physical quantity measurement main passage 50, is discharged to the outside of the housing 30 through the primary physical quantity measurement main passage outlets 501 and the secondary physical quantity measurement main passage outlets 502.

As discussed above, the air flow rate measurement device 21 measures the flow rate of the air and the temperature of the air. The air flow rate measurement device 21 achieves the improved measurement accuracy of the flow rate of the air. In the following description, the improvement of the measurement accuracy will be described.

In the air flow rate measurement device 21, the plurality of primary physical quantity measurement main passage outlets 501, which are communicated with the physical quantity measurement main passage 50, are formed at the primary housing lateral surface 51. Furthermore, the plurality of secondary physical quantity measurement main passage outlets 502, which are communicated with the physical quantity measurement main passage 50, are formed at the secondary housing lateral surface 52.

By providing the plurality of primary physical quantity measurement main passage outlets 501 and the plurality of secondary physical quantity measurement main passage outlets 502, a total cross-sectional area of the outlets of the physical quantity measurement main passage 50 can be increased, and a passage cross-sectional area of each of the outlets of the physical quantity measurement main passage 50 can be reduced. Therefore, a size of a contact area between an inner periphery of each of the primary physical quantity measurement main passage outlets 501 of the housing 30 and the air flowing in the physical quantity measurement main passage 50 is reduced. Furthermore, a size of a contact area between an inner periphery of each of the secondary physical quantity measurement main passage outlets 502 of the housing 30 and the air flowing in the physical quantity measurement main passage 50 is reduced. Therefore, the air, which flows in the physical quantity measurement main passage 50, is less likely to be disturbed when the air is discharged from the primary physical quantity measurement main passage outlets 501 and the secondary physical quantity measurement main passage outlets 502. Therefore, a size of vortexes, which are generated when the air flowing in the physical quantity measurement main passage 50 is discharged from the primary physical quantity measurement main passage outlets 501 and the secondary physical quantity measurement main passage outlets 502, becomes relatively small. Therefore, a change in the pressure of the air in the flow rate measurement main passage outlet 432 caused by the vortexes, is reduced, and thereby the flow of the air in the flow rate measurement main passage 43 is less likely to be changed. Since the flow of the air in the flow rate measurement main passage 43 is less likely to be changed, the flow of the air in the flow rate measurement sub-passage 44 is less likely to be changed. Therefore, since the variation in the output signal of the flow rate sensing device 75 is reduced, the flow rate sensing device 75 can achieve the improved measurement accuracy of the flow rate of the air which flows in the flow rate measurement sub-passage 44.

Furthermore, since the total cross-sectional area of the outlets can be increased, the flow rate of the air, which flows in the physical quantity measurement main passage 50, can be increased. Therefore, the primary physical quantity sensing device 81 can be easily cooled. Thus, the change in the temperature of the primary physical quantity sensing device 81, which is caused by the heat conduction and the heat transfer from, for example, the lid 33 of the housing 30, is reduced. As a result, since the variation in the value of the output signal of the primary physical quantity sensing device 81 is reduced, the primary physical quantity sensing device 81 can achieve the improved measurement accuracy of the temperature of the air which flows in the physical quantity measurement main passage 50.

Furthermore, the air flow rate measurement device 21 provides advantages discussed hereinafter.

The circuit board 76 is located in the physical quantity measurement main passage 50, and the primary physical quantity sensing device 81 is installed to the circuit board 76. Since the circuit board 76 is shaped in a form of a plate, a size of a contact area between the circuit board 76 and the air flowing in the physical quantity measurement main passage 50 can be made relatively small. For example, in this instance, the circuit board's thicknesswise surface 761, which is the surface of the circuit board 76 that extends in the plate thickness direction of the circuit board 76, is opposed to a portion of the physical quantity measurement main passage inlet 500. Therefore, since the size of the contact area between the circuit board 76 and the air flowing in the physical quantity measurement main passage 50 is made relatively small, the air, which flows in the physical quantity measurement main passage 50, is less likely to generate a vortex. Therefore, the air, which flows in the physical quantity measurement main passage 50, is less likely to generate the vortex when the air is discharged from the primary physical quantity measurement main passage outlets 501 and the secondary physical quantity measurement main passage outlets 502.

### Second Embodiment

A second embodiment is similar to the first embodiment except that the primary physical quantity sensing device is not installed to the circuit board, and the primary physical quantity sensing device is connected to a plurality of electrical wirings.

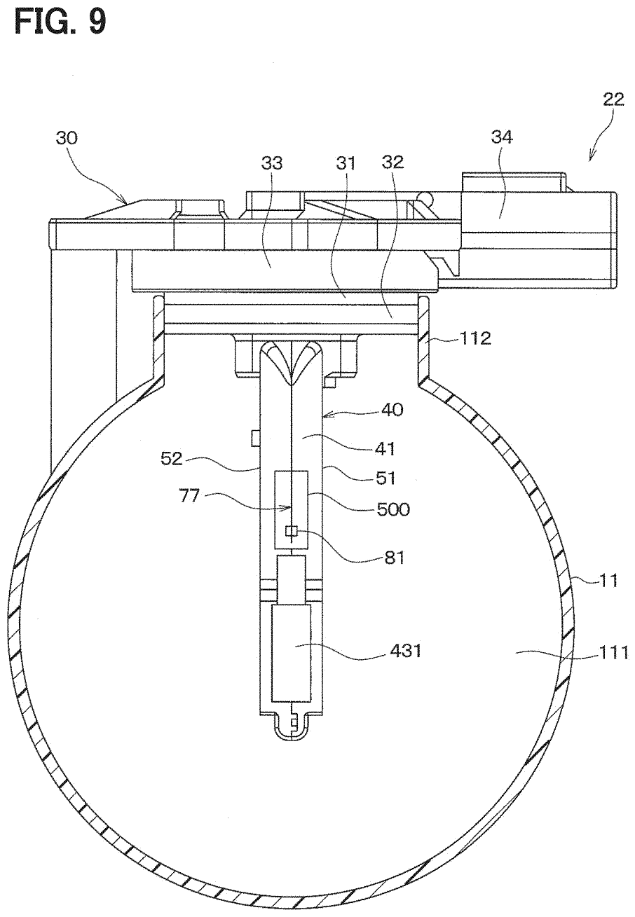

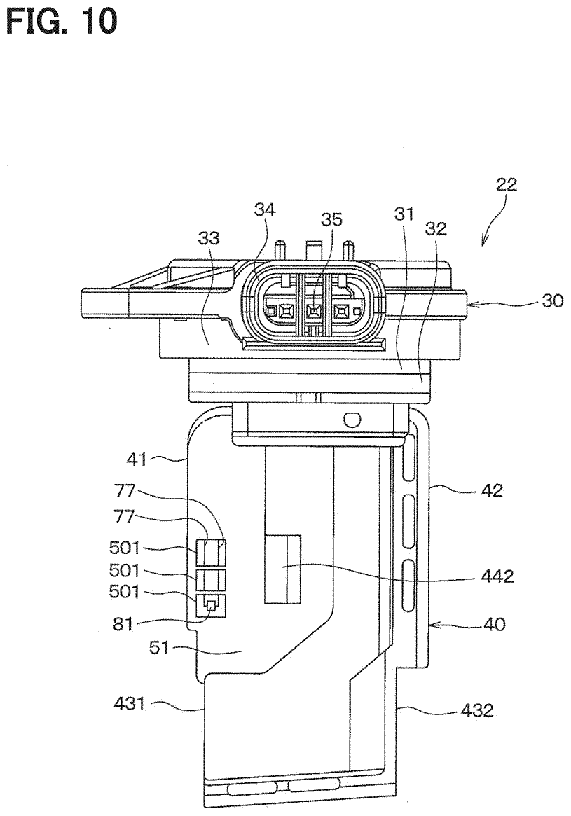

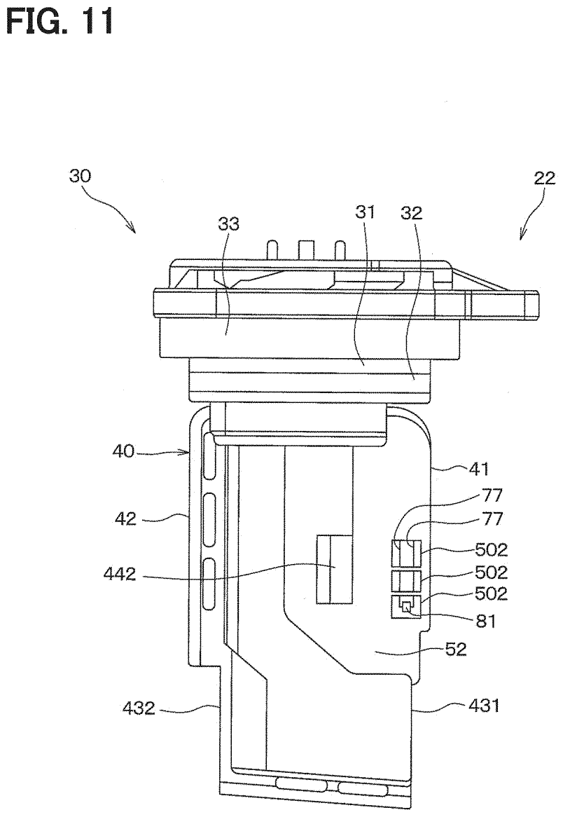

As shown in FIGS. 9 to 11, the air flow rate measurement device 22 of the second embodiment does not include the circuit board 76 but includes two electrical wirings 77. The electrical wirings 77 are opposed to the physical quantity measurement main passage inlet 500, the primary physical quantity measurement main passage outlets 501 and the secondary physical quantity measurement main passage outlets 502. Furthermore, one end of each of the electrical wirings 77 is electrically connected to the other end of the corresponding terminal 35. Furthermore, the other end of each of the electrical wirings 77 is electrically connected to the primary physical quantity sensing device 81. The output signal of the primary physical quantity sensing device 81 is transmitted to the electronic control device 18 through the electrical wirings 77 and the terminals 35.

The air flow rate measurement device 22 is constructed in the above-described manner. Like the first embodiment, the air flow rate measurement device 22 of the second embodiment can achieve the improved measurement accuracy of the flow rate of the air.

### Third Embodiment

A third embodiment is similar to the first embodiment except that the bypass portion includes a plurality of physical quantity measurement main passage inlets and a plurality of inlet partitions.

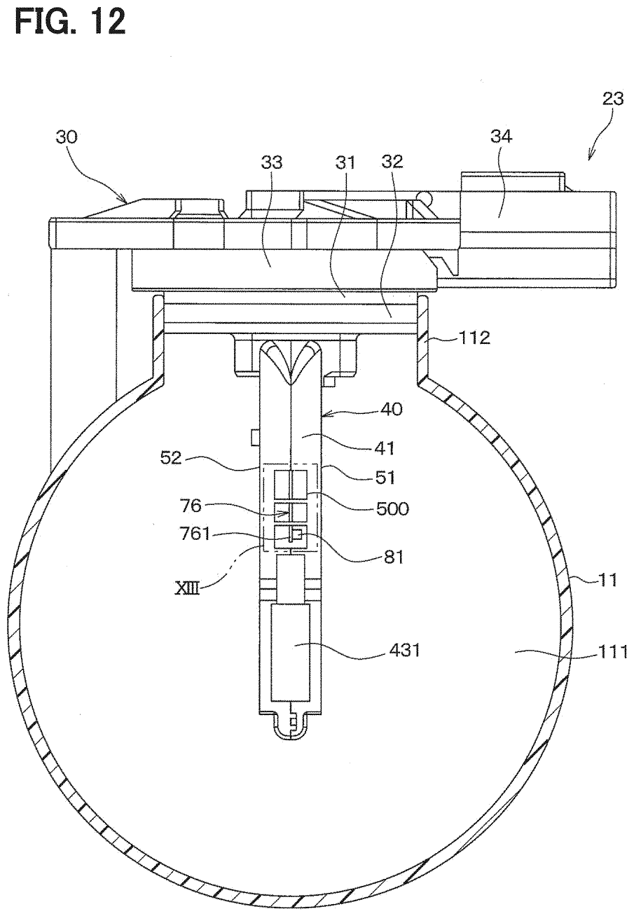

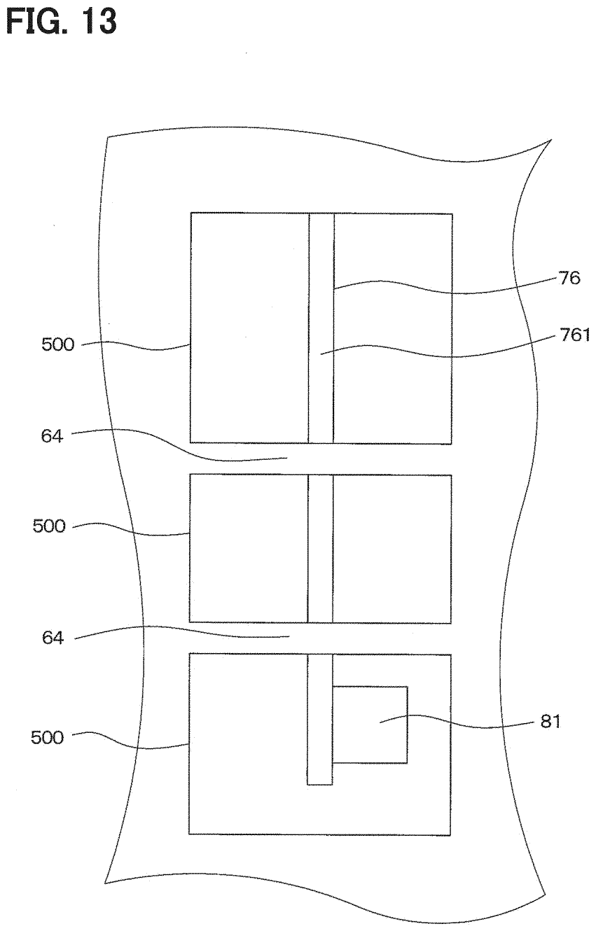

As shown in FIGS. 12 and 13, a plurality of physical quantity measurement main passage inlets 500 are formed at the housing base surface 41 of the bypass portion 40 of the air flow rate measurement device 23 according to the third embodiment. Furthermore, the bypass portion 40 has a plurality of inlet partitions 64.

As shown in FIG. 13, each of the inlet partitions 64 is located between corresponding adjacent two of the physical quantity measurement main passage inlets 500. Furthermore, each of the inlet partition 64 extends in a direction that is perpendicular to the top-to-bottom direction. Each of the inlet partitions 64 partitions between the corresponding adjacent two of the physical quantity measurement main passage inlets 500. In this instance, the number of the inlet partitions 64 is two, and these two inlet partitions 64 are arranged in parallel in the top-to-bottom direction. Furthermore, the number of the physical quantity measurement main passage inlets 500 is three, and these three physical quantity measurement main passage inlets 500 are arranged in parallel in the top-to-bottom direction.

The air flow rate measurement device 23 is constructed in the above-described manner. The air flow rate measurement device 23 of the third embodiment can achieve advantages which are similar to those of the first embodiment. Furthermore, in the third embodiment, since the plurality of physical quantity measurement main passage inlets 500 are formed, a total cross-sectional area of the inlets of the physical quantity measurement main passage 50 can be increased, and a passage cross-sectional area of each of the inlets of the physical quantity measurement main passage 50 can be reduced. Therefore, a size of a contact area between an inner periphery of each of the primary physical quantity measurement main passage inlets 500 of the housing 30 and the air flowing in the physical quantity measurement main passage 50 is reduced. Thus, the air, which is introduced into the physical quantity measurement main passage 50, is less likely to be disturbed. As a result, a size of vortexes, which are generated at the time of introducing the air into the physical quantity measurement main passage 50, becomes relatively small. Therefore, a size of vortexes, which are generated when the air flowing in the physical quantity measurement main passage 50 is discharged from the primary physical quantity measurement main passage outlets 501 and the secondary physical quantity measurement main passage outlets 502, becomes relatively small. Thus, like in the above-described one, the flow rate sensing device 75 can achieve the improved measurement accuracy of the flow rate of the air which flows in the flow rate measurement sub-passage 44.

### Fourth Embodiment

In a fourth embodiment, the airflow rate measurement device includes a plurality of secondary physical quantity sensing devices, and the bypass portion includes a physical quantity measurement sub-passage inlet, a physical quantity measurement sub-passage, a plurality of primary physical quantity measurement sub-passage outlets, a primary sub-passage outlet partition, a plurality of secondary physical quantity measurement sub-passage outlets and a secondary sub-passage outlet partition. The fourth embodiment is slimier to the first embodiment except for these points.

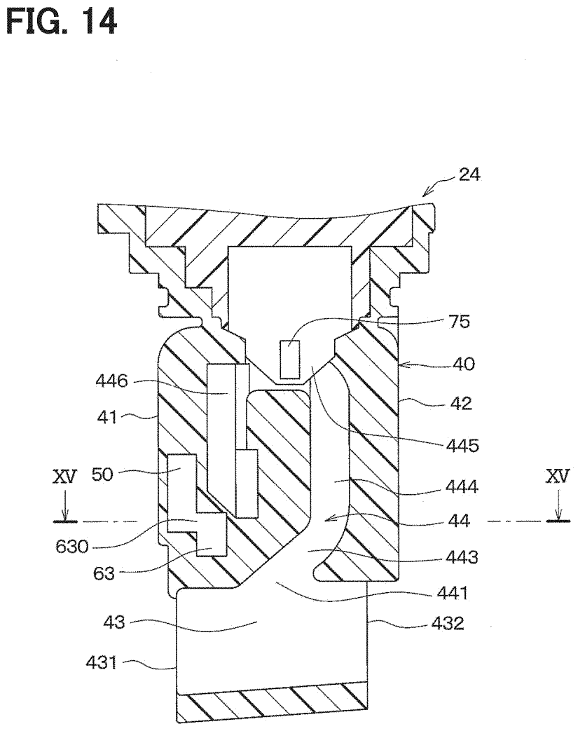

As shown in FIGS. 14 to 19, the bypass portion 40 of the air flow rate measurement device 24 of the fourth embodiment includes a physical quantity measurement sub-passage inlet 630, a physical quantity measurement sub-passage 63, a plurality of primary physical quantity measurement sub-passage outlets (a plurality of physical quantity measurement sub-passage outlets) 631 and a primary sub-passage outlet partition 71. The bypass portion 40 further includes a plurality of secondary physical quantity measurement sub-passage outlets (a plurality of physical quantity measurement sub-passage outlets) 632 and a secondary sub-passage outlet partition 72.

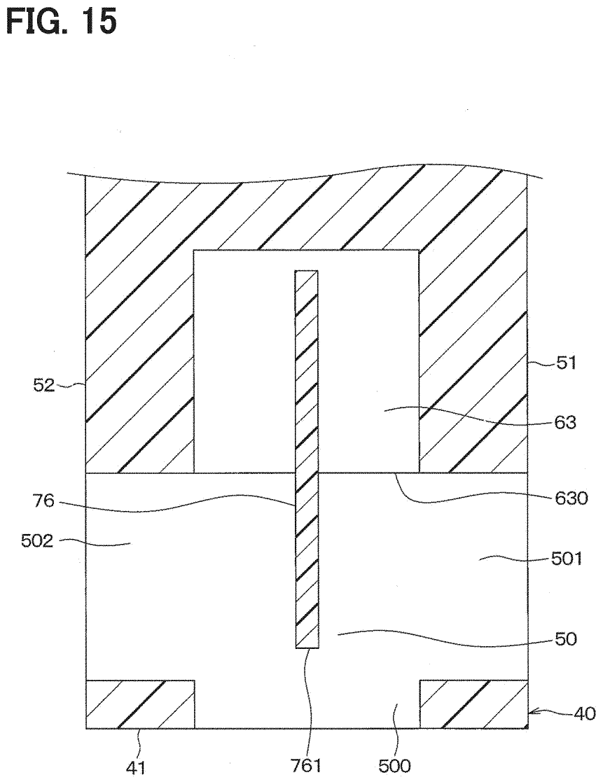

As shown in FIGS. 14 and 15, the physical quantity measurement sub-passage inlet 630 introduces a portion of the air, which flows in the physical quantity measurement main passage 50, into the physical quantity measurement sub-passage 63. The physical quantity measurement sub-passage 63 is a flow passage, which is branched from the middle of the physical quantity measurement main passage 50, and the physical quantity measurement sub-passage 63 is communicated with the physical quantity measurement sub-passage inlet 630 and is also communicated with the primary physical quantity measurement sub-passage outlets 631 and the secondary physical quantity measurement sub-passage outlets 632. In a cross-sectional view shown in FIG. 14, in order to clearly indicate the respective passages, an outline of the flow rate measurement sub-passage inlet 441, an outline of the respective secondary physical quantity measurement main passage outlets 502, an outline of the circuit board 73 and an outline of the physical quantity measurement sub-passage inlet 630 are omitted.

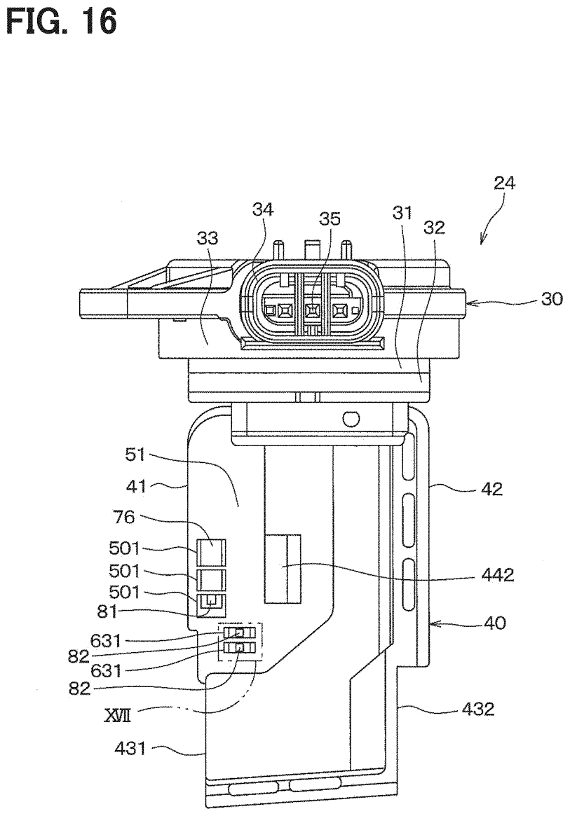

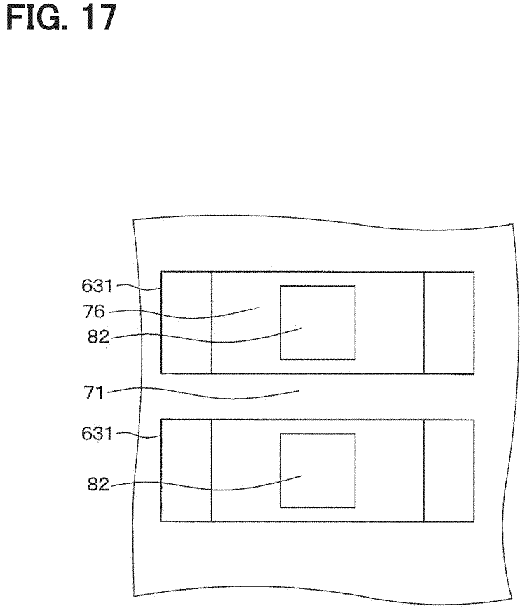

As shown in FIGS. 16 and 17, the plurality of primary physical quantity measurement sub-passage outlets 631 are formed at the primary housing lateral surface 51 at a location that is different from the location of the primary physical quantity measurement main passage outlets 501. Furthermore, the primary physical quantity measurement sub-passage outlets 631 are on the lower side of the primary physical quantity measurement main passage outlets 501 and are on the upper side of the flow rate measurement main passage inlet 431.

As shown in FIG. 17, the primary sub-passage outlet partition 71 is located between the primary physical quantity measurement sub-passage outlets 631. The primary sub-passage outlet partition 71 partitions between the primary physical quantity measurement sub-passage outlets 631. In this instance, the number of the primary sub-passage outlet partition 71 is one, and the number of the primary physical quantity measurement sub-passage outlets 631 is two. The primary sub-passage outlet partition 71 partitions these two primary physical quantity measurement sub-passage outlets 631 such that the primary physical quantity measurement sub-passage outlets 631 are arranged in parallel in the top-to-bottom direction.

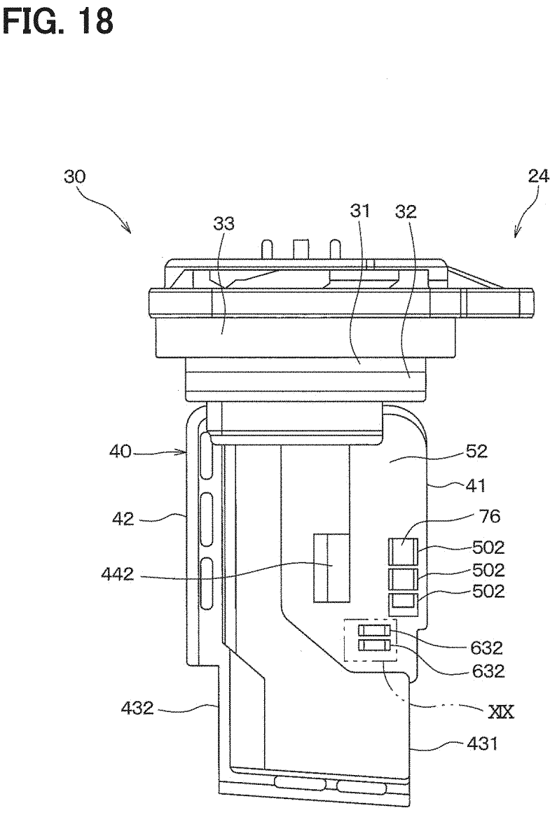

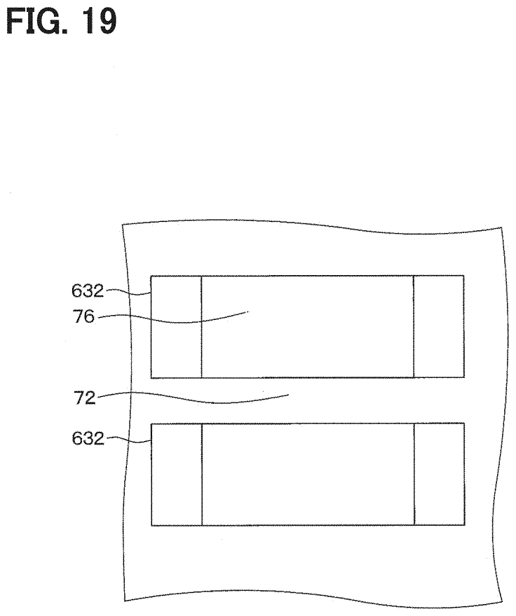

As shown in FIGS. 18 and 19, the plurality of secondary physical quantity measurement sub-passage outlets 632 are formed at the secondary housing lateral surface 52 at a location that is different from the location of the secondary physical quantity measurement main passage outlets 502. Furthermore, the secondary physical quantity measurement sub-passage outlets 632 are on the lower side of the secondary physical quantity measurement main passage outlets 502 and are on the upper side of the flow rate measurement main passage inlet 431.

As shown in FIG. 19, the secondary sub-passage outlet partition 72 is located between the secondary physical quantity measurement sub-passage outlets 632. The secondary sub-passage outlet partition 72 partitions between the secondary physical quantity measurement sub-passage outlets 632. In this instance, the number of the secondary sub-passage outlet partition 72 is one, and the number of the secondary physical quantity measurement sub-passage outlets 632 is two. The secondary sub-passage outlet partition 72 partitions these two secondary physical quantity measurement sub-passage outlets 632 such that the secondary physical quantity measurement sub-passage outlets 632 are arranged in parallel in the top-to-bottom direction.

Furthermore, the air flow rate measurement device 24 includes two secondary physical quantity sensing devices 82. In the air flow rate measurement device 24, as shown in FIG. 15, the circuit board 76 extends from a portion of the circuit board 76, which is located in the physical quantity measurement main passage 50, to the physical quantity measurement sub-passage 63. The secondary physical quantity sensing devices 82 are installed to the circuit board 76 along with the primary physical quantity sensing device 81 and are placed in the physical quantity measurement sub-passage 63. Furthermore, the circuit board 76 is opposed to the primary physical quantity measurement sub-passage outlets 631 and the secondary physical quantity measurement sub-passage outlets 632, and each of the secondary physical quantity sensing devices 82 is opposed to a corresponding one of the primary physical quantity measurement sub-passage outlets 631. Each of the secondary physical quantity sensing devices 82 outputs a signal which corresponds to a corresponding physical quantity of the air that flows in the physical quantity measurement sub-passage 63. The physical quantities, which are respectively sensed by the secondary physical quantity sensing devices 82, are different from the physical quantity which is sensed by the primary physical quantity sensing device 81. In this instance, the physical quantities, which are respectively sensed by the secondary physical quantity sensing devices 82, are a relative humidity and a pressure of the air which flows in the physical quantity measurement sub-passage 63. For example, one of the secondary physical quantity sensing devices 82 senses the relative humidity of the air, which flows in the physical quantity measurement sub-passage 63, based on a change in a dielectric constant of a polymer film that is induced by a change in the relative humidity of the air which flows in the physical quantity measurement sub-passage 63. Further, the other one of the secondary physical quantity sensing devices 82 senses the pressure of the air, which flows in the physical quantity measurement sub-passage 63, based on a change in an electric resistance of, for example, a semiconductor induced by a change in the pressure.

Further, in the air flow rate measurement device 24 of the fourth embodiment, a portion of the air, which flows in the physical quantity measurement main passage 50, is discharged to the outside of the housing 30 through the primary physical quantity measurement main passage outlets 501 and the secondary physical quantity measurement main passage outlets 502. Also, another portion of the air, which flows in the physical quantity measurement main passage 50, flows into the physical quantity measurement sub-passage 63 through the physical quantity measurement sub-passage inlet 630. A portion of the air, which flows in the physical quantity measurement sub-passage 63, contacts the secondary physical quantity sensing devices 82. In response to the contact with the air, the secondary physical quantity sensing devices 82 respectively output the signals that respectively correspond to the relative humidity and the pressure of the air which flows in the physical quantity measurement sub-passage 63. The output signals of the secondary physical quantity sensing devices 82 are transmitted to the electronic control device 18 through the circuit board 76 and the corresponding terminals 35. Furthermore, the air, which flows in the physical quantity measurement sub-passage 63, is discharged to the outside of the housing 30 through the primary physical quantity measurement sub-passage outlets 631 and the secondary physical quantity measurement sub-passage outlets 632.

The air flow rate measurement device 24 is constructed in the above-described manner. The air flow rate measurement device 24 of the fourth embodiment can achieve advantages which are similar to those of the first embodiment. Furthermore, as described above, the size of the vortexes, which are generated by the primary physical quantity measurement sub-passage outlets 631 and the secondary physical quantity measurement sub-passage outlets 632 at the time of discharging the air from the physical quantity measurement sub-passage 63 to the outside of the housing 30, becomes relatively small. Therefore, advantages, which are similar to those discussed above, can be achieved. Furthermore, the air flow rate measurement device 24 of the fourth embodiment can measure the plurality of physical quantities of the air which are different from the flow rate of the air.

### Other Embodiments

The present disclosure is not necessarily limited to the above embodiments, and the above embodiments may be suitably modified. Further, in each of the above embodiments, it is needless to say that the elements constituting the embodiment are not necessarily essential unless explicitly specified as being essential or in principle considered to be essential.

(1) In the above embodiments, each of the primary main passage outlet partitions 61 and the secondary main passage outlet partitions 62 extends in the direction that is perpendicular to the top-to-bottom direction. The extending direction of each of the primary main passage outlet partitions 61 and the secondary main passage outlet partitions 62 should not be limited to the direction perpendicular to the top-to-bottom direction and may be, for example, the top-to-bottom direction. Furthermore, the extending direction of each of the primary main passage outlet partitions 61 and the secondary main passage outlet partitions 62 may be a direction that intersects the top-to-bottom direction. As described above, the side of the bypass portion 40, at which the holding portion 31 of the housing 30 is placed, is referred to as the upper side. Furthermore, the other side of the bypass portion 40, which is opposite to the holding portion 31, is referred to as the lower side.

(2) In the above embodiments, the primary physical quantity sensing device 81 outputs the signal which corresponds to the temperature of the air flowing in the physical quantity measurement main passage 50. However, the primary physical quantity sensing device 81 should not be limited to the above configuration where the primary physical quantity sensing device 81 outputs the signal which corresponds to the temperature of the air flowing in the physical quantity measurement main passage 50, and the primary physical quantity sensing device 81 may be configured to output a signal which corresponds to a relative humidity of the air flowing in the physical quantity measurement main passage 50. Further alternatively, the primary physical quantity sensing device 81 may output a signal, which corresponds to a pressure of the air flowing in the physical quantity measurement main passage 50. Furthermore, in the above embodiments, the primary physical quantity sensing device 81 is exposed in the physical quantity measurement main passage 50. However, the primary physical quantity sensing device 81 should not be limited to this configuration where the primary physical quantity sensing device 81 is exposed in the physical quantity measurement main passage 50, and the primary physical quantity sensing device 81 may be covered by, for example, resin to limit corrosion of the primary physical quantity sensing device 81.

(3) In the above embodiments, the plurality of primary physical quantity measurement main passage outlets 501 are formed at the primary housing lateral surface 51, and the plurality of secondary physical quantity measurement main passage outlets 502 are formed at the secondary housing lateral surface 52. Alternatively, while the plurality of primary physical quantity measurement main passage outlets 501 are formed at the primary housing lateral surface 51 the secondary physical quantity measurement main passage outlets 502 may be eliminated from the secondary housing lateral surface 52. Further alternatively, while the plurality of secondary physical quantity measurement main passage outlets 502 are formed at the secondary housing lateral surface 52, the primary physical quantity measurement main passage outlets 501 may be eliminated from the primary housing lateral surface 51.

(4) In the above embodiments, the circuit board's thicknesswise surface 761, which is the surface of the circuit board 76 that extends in the plate thickness direction of the circuit board 76, is opposed to the portion of the physical quantity measurement main passage inlet 500. However, the circuit board's thicknesswise surface 761, which is the surface of the circuit board 76 that extends in the plate thickness direction of the circuit board 76, is not necessarily opposed to the portion of the physical quantity measurement main passage inlet 500, and the circuit board's thicknesswise surface 761 may be opposed to another portion of the housing base surface 41 that is other than the portion of the housing base surface 41 where the physical quantity measurement main passage inlet 500 is formed.

(5) In the above embodiments, the number of the primary physical quantity measurement main passage outlets 501 is three, and the number of the secondary physical quantity measurement main passage outlets 502 is three. However, the number of the primary physical quantity measurement main passage outlets 501 and the number of the secondary physical quantity measurement main passage outlets 502 should not be respectively limited to three and may be changed to two or four or more. Furthermore, in the above embodiments, the primary physical quantity measurement main passage outlets 501 and the secondary physical quantity measurement main passage outlets 502 are respectively shaped in an elongated rectangular shape. However, the shape of the respective primary physical quantity measurement main passage outlets 501 and the shape of the respective secondary physical quantity measurement main passage outlets 502 are not necessarily limited to the elongated rectangular shape and may be a polygonal shape, a circular shape or an elliptical shape.

(6) In the third embodiment, the number of physical quantity measurement main passage inlets 500 is three. However, the number of the physical quantity measurement main passage inlets 500 is not necessarily limited to three and may be changed to two or four or more. Furthermore, in the above embodiments, the physical quantity measurement main passage inlet 500 is shaped in an elongate rectangular shape. However, the shape of the physical quantity measurement main passage inlet 500 is not necessarily limited to the elongated rectangular shape and may be a polygonal shape, a circular shape or an elliptical shape.

(7) In the third embodiment, each of the inlet partitions 64 extends in the direction that is perpendicular to the top-to-bottom direction. However, the extending direction of each of the inlet partitions 64 should not be limited to the direction that is perpendicular to the top-to-bottom direction, and the extending direction of the inlet partition 64 may be changed to the top-to-bottom direction. Further alternatively, the extending direction of the inlet partition 64 may be a direction that intersects the top-to-bottom direction.

(8) In the fourth embodiment, the secondary physical quantity sensing devices 82 respectively output the signals which respectively correspond to the relative humidity and the pressure of the air flowing into the physical quantity measurement sub-passage 63. However, the secondary physical quantity sensing devices 82 should not be limited to the above configuration where the secondary physical quantity sensing devices 82 respectively output the signals which respectively correspond to the relative humidity and the pressure of the air flowing into the physical quantity measurement sub-passage 63, and the secondary physical quantity sensing device(s) 82 may output a signal which corresponds to the temperature of the air flowing in the physical quantity measurement sub-passage 63. Furthermore, in the above embodiments, the secondary physical quantity sensing devices 82 are exposed in the physical quantity measurement sub-passage 63. However, the secondary physical quantity sensing devices 82 should not be limited to this configuration where the secondary physical quantity sensing devices 82 are exposed in the physical quantity measurement sub-passage 63, and the secondary physical quantity sensing devices 82 may be covered by, for example, resin to limit corrosion of the secondary physical quantity sensing devices 82.

(9) In the fourth embodiment, the number of the primary physical quantity measurement sub-passage outlets 631 is two, and the number of the secondary physical quantity measurement sub-passage outlets 632 is two. However, the number of the primary physical quantity measurement sub-passage outlets 631 and the number of the secondary physical quantity measurement sub-passage outlets 632 should not be respectively limited to two and may be changed to three or more. Furthermore, in the above embodiments, the primary physical quantity measurement sub-passage outlets 631 and the secondary physical quantity measurement sub-passage outlets 632 are respectively shaped in an elongated rectangular shape. However, the shape of the respective primary physical quantity measurement sub-passage outlets 631 and the shape of the respective secondary physical quantity measurement sub-passage outlets 632 are not necessarily limited to the elongated rectangular shape and may be a polygonal shape, a circular shape or an elliptical shape.

(10) In the fourth embodiment, the plurality of secondary physical quantity measurement sub-passage outlets 632 are formed at the primary housing lateral surface 51, and the plurality of secondary physical quantity measurement sub-passage outlets 632 are formed at the secondary housing lateral surface 52. Alternatively, while the plurality of primary physical quantity measurement sub-passage outlets 631 are formed at the primary housing lateral surface 51, the secondary physical quantity measurement sub-passage outlets 632 may be eliminated from the secondary housing lateral surface 52. Alternatively, while the plurality of secondary physical quantity measurement sub-passage outlets 632 are formed at the secondary housing lateral surface 52, the primary physical quantity measurement sub-passage outlets 631 may be eliminated from the primary housing lateral surface 51.

(11) The air flow rate measurement device 22 of the second embodiment and the air flow rate measurement device 23 of the third embodiment may be combined together. Specifically, the bypass portion 40 of the air flow rate measurement device 22 of the second embodiment may include a plurality of physical quantity measurement main passage inlets 500. The bypass portion 40 of the air flow rate measurement device 22 of the second embodiment may include the inlet partitions 64.

(12) The air flow rate measurement device 22 of the second embodiment and the air flow rate measurement device 24 of the fourth embodiment may be combined together. Specifically, the bypass portion 40 of the air flow rate measurement device 22 of the second embodiment may include the physical quantity measurement sub-passage inlet 630, the physical quantity measurement sub-passage 63, the plurality of primary physical quantity measurement sub-passage outlets 631, the primary sub-passage outlet partition 71, the plurality of secondary physical quantity measurement sub-passage outlets 632 and the secondary sub-passage outlet partition 72.

(13) The air flow rate measurement device 23 of the third embodiment and the air flow rate measurement device 24 of the fourth embodiment may be combined together. Specifically, the bypass portion 40 of the air flow rate measurement device 23 of the third embodiment may include the physical quantity measurement sub-passage inlet 630, the physical quantity measurement sub-passage 63, the plurality of primary physical quantity measurement sub-passage outlets 631, the primary sub-passage outlet partition 71, the plurality of secondary physical quantity measurement sub-passage outlets 632 and the secondary sub-passage outlet partition 72.

(14) The air flow rate measurement device 22 of the second embodiment, the air flow rate measurement device 23 of the third embodiment and the air flow rate measurement device 24 of the fourth embodiment may be combined together.

(15) In the above embodiments, the pipe extension 112 is shaped in the cylindrical tubular form. However, the pipe extension 112 is not necessarily shaped in the cylindrical tubular form. For example, the pipe extension 112 may be shaped in another tubular form, such as a polygonal tubular form.

(16) In the above embodiments, the holding portion 31 is shaped in the cylindrical tubular form. However, the holding portion 31 is not necessarily shaped in the cylindrical tubular form. For example, the holding portion 31 may be shaped in another tubular form, such as a polygonal tubular form.

(17) In the above embodiments, the connector cover 34 extends from the radially inner side toward the radially outer side of the holding portion 31. However, the connector cover 34 does not necessarily extend from the radially inner side toward the radially outer side of the holding portion 31. For example, the connector cover 34 may extend in the axial direction of the holding portion 31.

(18) In the above embodiments, the flow rate measurement sub-passage 44 is the passage that is branched from the middle of the flow rate measurement main passage 43. However, the flow rate measurement sub-passage 44 is not necessarily limited to the passage that is branched from the middle of the flow rate measurement main passage 43. For example, instead of communicating the flow rate measurement main passage 43 with the flow rate measurement main passage outlet 432, the flow rate measurement sub-passage 44 may be communicated with the flow rate measurement main passage outlet 432 such that the flow rate measurement main passage 43 and the flow rate measurement sub-passage 44 form one flow passage.

What is claimed is:

1. An air flow rate measurement device comprising:
a housing that has:
a base surface;
a back surface that is opposed to the base surface;
a primary lateral surface that is connected to one end part of the base surface and one end part of the back surface;
a secondary lateral surface that is connected to another end part of the base surface, which is opposite to the primary lateral surface, and another end part of the back surface, which is opposite to the primary lateral surface;
a flow rate measurement passage inlet that is formed at the base surface;
a flow rate measurement passage outlet that is formed at the back surface;
a flow rate measurement passage that is communicated with the flow rate measurement passage inlet and the flow rate measurement passage outlet;
a physical quantity measurement main passage inlet that is formed at the base surface;
a physical quantity measurement main passage outlet that is formed at the primary lateral surface; and
a physical quantity measurement main passage that is communicated with the physical quantity measurement main passage inlet and the physical quantity measurement main passage outlet;
a flow rate sensing device that is located in the flow rate measurement passage and is configured to output a signal which corresponds to a flow rate of air flowing in the flow rate measurement passage; and
a physical quantity sensing device that is located in the physical quantity measurement main passage and is configured to output a signal which corresponds to a physical quantity of the air flowing in the physical quantity measurement main passage, wherein:
the housing has the physical quantity measurement main passage outlet as one of a plurality of physical quantity measurement main passage outlets formed at the primary lateral surface.

2. The air flow rate measurement device according to claim 1, wherein the housing has a main passage outlet partition that is formed between adjacent two of the plurality of physical quantity measurement main passage outlets.

3. The airflow rate measurement device according to claim 1, wherein the physical quantity sensing device is configured to output a signal which corresponds to a temperature of the air flowing in the physical quantity measurement main passage.

4. The air flow rate measurement device according to claim 1, wherein the physical quantity sensing device is installed to a circuit board located in the physical quantity measurement main passage.

5. The air flow rate measurement device according to claim 4, wherein a surface of the circuit board, which extends in a plate thickness direction of the circuit board, is opposed to one of the base surface and the physical quantity measurement main passage inlet.

6. The air flow rate measurement device according to claim 1, wherein the physical quantity sensing device is connected to an electrical wiring located in the physical quantity measurement main passage.

7. The air flow rate measurement device according to claim 1 wherein:
the physical quantity measurement main passage inlet is one of a plurality of physical quantity measurement main passage inlets formed at the base surface; and
the housing has an inlet partition that is formed between adjacent two of the plurality of physical quantity measurement main passage inlets.

8. The air flow rate measurement device according to claim 1, wherein:
the physical quantity measurement main passage outlet is a primary physical quantity measurement main passage outlet; and
the housing has:
the primary physical quantity measurement main passage outlet as one of a plurality of primary physical quantity measurement main passage outlets formed at the primary lateral surface; and
a plurality of secondary physical quantity measurement main passage outlets that are communicated with the physical quantity measurement main passage and formed at the secondary lateral surface.

9. The air flow rate measurement device according to claim 1, wherein:
the housing has:
a physical quantity measurement sub-passage that is communicated with the physical quantity measurement main passage; and
a plurality of physical quantity measurement sub-passage outlets that are formed at the primary lateral surface and are communicated with the physical quantity measurement sub-passage.

10. The air flow rate measurement device according to claim 9, wherein:
the physical quantity sensing device is a primary physical quantity sensing device; and
the air flow rate measurement device comprises a secondary physical quantity sensing device that is located in the physical quantity measurement sub-passage and is configured to output a signal which corresponds to a physical quantity of the air flowing in the physical quantity measurement sub-passage.

11. The air flow rate measurement device according to claim 10, wherein the secondary physical quantity sensing device is configured to output a signal that corresponds to a relative humidity of the air flowing in the physical quantity measurement sub-passage.

12. The air flow rate measurement device according to claim 10, wherein the secondary physical quantity sensing device is configured to output a signal which corresponds to a pressure of the air flowing in the physical quantity measurement sub-passage.

13. The air flow rate measurement device according to claim 9, wherein the housing has a sub-passage outlet partition that is formed between adjacent two of the plurality of physical quantity measurement sub-passage outlets.
